(19) United States
(12) Patent Application Publication
(10) Pub. No.: US 2025/0184034 A1
(43) Pub. Date: Jun. 5, 2025

(54) DETERMINING PUNCTURING ASSUMPTION FOR THE SYNCHRONIZATION AND PHYSICAL BROADCAST CHANNEL

(71) Applicant: Nokia Technologies Oy, Espoo (FI)

(72) Inventors: Sami-Jukka HAKOLA, Kempele (FI); Esa Tapani TIIROLA, Oulu (FI); Kari Juhani HOOLI, Oulu (FI); Jorma Johannes KAIKKONEN, Oulu (FI); Pasi Eino Tapio KINNUNEN, Oulu (FI)

(73) Assignee: Nokia Technologies Oy, Espoo (FI)

(21) Appl. No.: 18/838,737

(22) PCT Filed: Feb. 16, 2022
(86) PCT No.: PCT/EP2022/053817

§ 371 Date: Aug. 15, 2024

(51) Int. Cl. H04L 1/00; H04L 5/00

(52) U.S. Cl. CPC H04L 1/0013; H04L 5/005

(57) ABSTRACT

Techniques of determining punctured PRBs for an SSB include determining a puncturing to be applied to an incoming SSB if the SSB falls out of band or upon a minimum guard band of the band. In some implementations, when there is a specified total puncturing, the UE performs puncturing on resources at the opposite end of the SSB.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes detecting, by a user equipment within a wireless network, a synchronization signal block on a synchronization raster point within a specified frequency band. The method also includes determining, by the user equipment, that the specified frequency band is not sufficiently wide to accommodate the synchronization signal block based on the synchronization raster point. The method further includes, in response to the specified frequency band being determined to not be sufficiently wide to accommodate the synchronization signal block, identifying a number of physical resource blocks on a first end of the synchronization signal block to be punctured.

According to an example implementation, an apparatus includes at least one processor and at least one memory including computer program code, the at least one memory and the computer program code configured to, with the at least one processor, cause the apparatus at least to detect, by a user equipment within a wireless network, a synchronization signal block on a synchronization raster point within a specified frequency band. The at least one memory and the computer program code are also configured to, with the at least one processor, cause the apparatus at least to determine, by the user equipment, that the specified frequency band is not sufficiently wide to accommodate the synchronization signal block based on the synchronization raster point. The at least one memory and the computer program code are further configured to, with the at least one processor, cause the apparatus at least to, in response to the specified frequency band being determined to not be sufficiently wide to accommodate the synchronization signal block, identify a number of physical resource blocks on a first end of the synchronization signal block to be punctured.

According to an example implementation, an apparatus includes means for detecting, by a user equipment within a wireless network, a synchronization signal block on a synchronization raster point within a specified frequency band. The apparatus also includes means for determining, by the user equipment, that the specified frequency band is not sufficiently wide to accommodate the synchronization signal block based on the synchronization raster point. The apparatus further includes means for, in response to the specified frequency band being determined to not be sufficiently wide to accommodate the synchronization signal block, identifying a number of physical resource blocks on a first end of the synchronization signal block to be punctured.

According to an example implementation, a computer program product includes a computer-readable storage medium and storing executable code that, when executed by at least one data processing apparatus, is configured to cause the at least one data processing apparatus to detect, by a user equipment within a wireless network, a synchronization signal block on a synchronization raster point within a specified frequency band. The computer-readable storage medium also stores executable code that, when executed by at least one data processing apparatus, is configured to cause the at least one data processing apparatus to determine, by the user equipment, that the specified frequency band is not sufficiently wide to accommodate the synchronization signal block based on the synchronization raster point. The computer-readable storage medium further stores executable code that, when executed by at least one data processing apparatus, is configured to cause the at least one data processing apparatus to, in response to the specified frequency band being determined to not be sufficiently wide to accommodate the synchronization signal block, identify a number of physical resource blocks on a first end of the synchronization signal block to be punctured.

According to an example implementation, a method includes obtaining, by a network node of a wireless network, a band of frequencies having a bandwidth available for transmission of a physical broadcast channel. The method also includes, in response to the available bandwidth being sufficient for transmission of the physical broadcast channel, determining, by the network node, a synchronization raster point such that the physical broadcast channel fits within the band. The method further includes, in response to the available bandwidth being insufficient for transmission of the physical broadcast channel, determining, by the network node, a synchronization raster point such that at least one physical resource block of the physical broadcast channel is outside the band.

According to an example implementation, an apparatus includes at least one processor and at least one memory including computer program code, the at least one memory and the computer program code configured to, with the at least one processor, cause the apparatus at least to obtain, by a network node of a wireless network, a band of frequencies having a bandwidth available for transmission of a physical broadcast channel. The at least one memory and the computer program code are also configured to in response to the available bandwidth being sufficient for transmission of the physical broadcast channel, determine, by the network node, a synchronization raster point such that the physical broadcast channel fits within the band. The at least one memory and the computer program code are further configured to, in response to the available bandwidth being insufficient for transmission of the physical broadcast channel, determine, by the network node, a synchronization raster point such that at least one physical resource block of the physical broadcast channel is outside the band.

According to an example implementation, an apparatus includes means for obtaining, by a network node of a wireless network, a band of frequencies having a bandwidth available for transmission of a physical broadcast channel. The apparatus also includes means for, in response to the available bandwidth being sufficient for transmission of the physical broadcast channel, determining, by the network node, a synchronization raster point such that the physical broadcast channel fits within the band. The apparatus further includes means for, in response to the available bandwidth being insufficient for transmission of the physical broadcast channel, determining, by the network node, a synchronization raster point such that at least one physical resource block of the physical broadcast channel is outside the band.

According to an example implementation, a computer program product includes a computer-readable storage medium and storing executable code that, when executed by at least one data processing apparatus, is configured to cause the at least one data processing apparatus to obtain, by a network node of a wireless network, a band of frequencies having a bandwidth available for transmission of a physical broadcast channel. The executable code, when executed by at least one data processing apparatus, is also configured to cause the at least one data processing apparatus to, in response to the available bandwidth being sufficient for transmission of the physical broadcast channel, determine, by the network node, a synchronization raster point such that the physical broadcast channel fits within the band. The executable code, when executed by at least one data processing apparatus, is further configured to cause the at least one data processing apparatus to, in response to the available bandwidth being insufficient for transmission of the physical broadcast channel, determine, by the network node, a synchronization raster point such that at least one physical resource block of the physical broadcast channel is outside the band.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating existing NR initial access signals and channels with a 15 kHz subcarrier spacing, according to an example implementation.

FIG. 3 is a diagram illustrating different puncturing patterns for synchronization signal block (SSB), according to an example implementation.

FIGS. 4A-4B are diagrams illustrating a conventional puncturing procedure based on a sync raster point, according to an example implementation.

FIGS. 5A-5C are diagrams illustrating an improved puncturing procedure by which a puncturing pattern may be determined, according to an example implementation.

FIG. 6 is a flow chart illustrating a process to determine a SSB puncturing pattern from a UE perspective, according to an example implementation.

FIG. 7 is a flow chart illustrating a process to determine a SSB puncturing pattern from a gNB perspective, according to an example implementation.

FIG. 8 is a flow chart illustrating a process to determine a SSB puncturing pattern from a UE perspective according to an example implementation.

FIG. 9 is a flow chart illustrating a process to determine a SSB puncturing pattern from a gNB perspective according to an example implementation.

FIG. 10 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

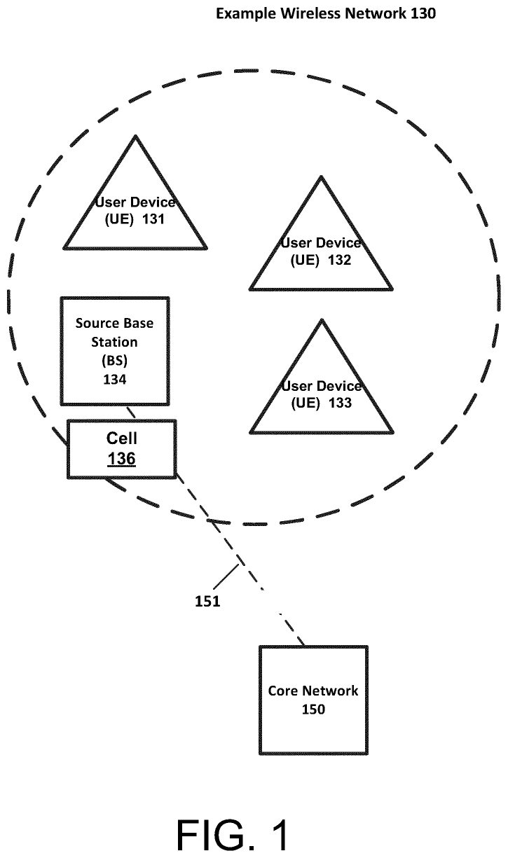

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

Some scenarios are emerging in which it may be beneficial to enable the operation of 5G NR in a narrower bandwidth than the 5 MHz channels for which it was originally designed, e.g. down to 3 MHz. For example, deployment of NR for Future Railway Mobile Communication System (FRMCS) in the 900 MHz band needs to take place alongside legacy GSM-R carriers within a 5.6 MHz bandwidth, which permits only about 3.6 MHz to be used for NR. It is noted that this bandwidth may vary from cell-to-cell, and also in time, e.g., the bandwidth may increase over time. Similarly, there are some cases where only 3 MHz channels are available for NR.

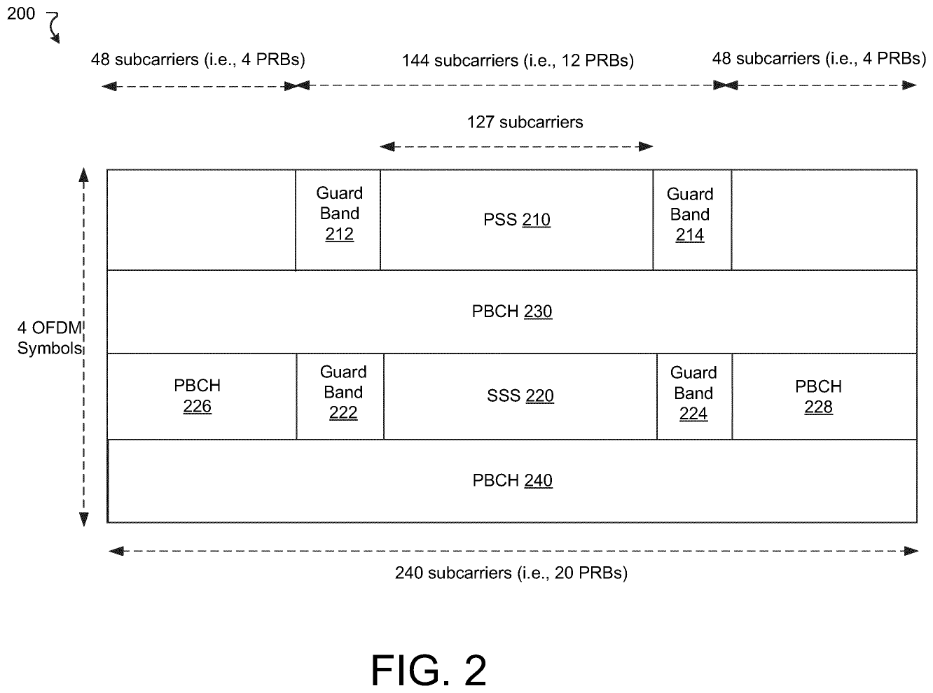

Some signals and channels transmitted, more specifically signals and channels of the synchronization signal and physical broadcast channel (PBCH) block (SSB), by the NR base stations (gNBs) were not designed for transmission in such narrow channels, as shown in FIG. 2.

FIG. 2 is a diagram illustrating example existing NR initial access signals and channels 200 with a 15 kHz subcarrier spacing. Accordingly, the 240 subcarriers across the 3.6 MHz bandwidth shown in FIG. 2 corresponds to 20 physical resource blocks (PRBs). As shown in FIG. 2, there are four orthogonal frequency-division multiplexed (OFDM) symbols. Two of the OFDM symbols have a PSS or SSS (127 subcarriers) with guard bands 212, 214, 222, 224 (8 subcarriers each) adjacent to respective PBCHs (48 subcarriers, 4 PRBs). The other two OFDM symbols have PBCHs that occupy over the entire 3.6 MHz bandwidth (240 subcarriers, 20 PRBs).

The UE, after detecting the PSS 210 and SSS 220, knows in addition to the physical cell ID, slot timing within a 5 ms half-frame and symbol timing. The UE can then determine resource elements for a PBCH demodulation reference signal (DMRS) and data to receive a PBCH payload. The PBCH carries Master Information Block (MIB), signalling, the most essential system information related to the frequency position i.e., SSB frequency domain allocation related to a common resource block (CRB) grid, and timing, i.e., half frame timing and frame timing. The information is contained either in higher layer payload (i.e. IB), as a part of the physical layer bits in the transport block payload, or in DMRS.

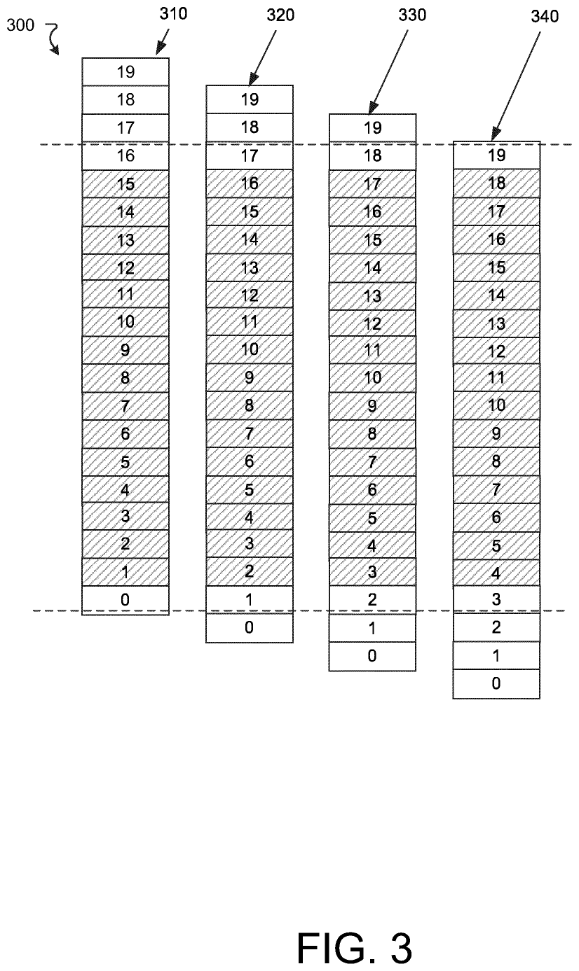

FIG. 3 is a diagram illustrating different possible puncturing patterns 310, 320, 330, 340 for the SSB 300 described above. A 3 MHz allocation to a NR system would mean a 15 PRB channel bandwidth, assuming a 90% spectrum utilization. For SSB, this would mean a 5 PRB puncturing, i.e., making 5 PRBs of the 15 PRBs in the channel bandwidth unavailable. To enable the UEs can use the existing searcher/PSS and SSS detector hardware implementation and in order not to impact negatively on the cell detection performance (e.g. during initial cell search), it is preferable to keep the PSS and SSS signals unaffected by the puncturing. To ensure this, there is a maximum 4 PRB puncturing per side that can take place. In other words, applicable puncturing patterns are 1+4, 2+3, 3+2, 4+1 as shown in FIG. 3. In some implementations, for allocations other than 3 MHz bandwidth, other puncturing patterns are possible.

A relevant question is, what effect does puncturing have on PBCH detection performance? To answer the question, evaluations were carried out with the following assumptions.
Two-sided symmetric puncturing of PBCH (2/4/6/8 PRBs), no remapping;
No power boosting;
AWGN interference is used to mimic GSM-R interference on part of PRBs;
gNB does not transmit PBCH on those GSM-R “PRB”s
   Option #1: UE does detection assuming correct knowledge of PBCH transmission bandwidth (BW),
   Option #2: UE does detection assuming full PBCH transmission BW.

The SNR loss due to puncturing, with Option #1, is as follows:

| Interference | |
|---|---|
| power vs. | |
| PBCH power | SNR loss (dB) due to puncturing |

| (dB) | 2 PRBs | 4 PRBs | 6 PRBs | 8 PRBs |
|---|---|---|---|---|
| −100 | 0.97 | 1.94 | 3.47 | 5.88 |
| 0 | 0.64 | 1.78 | 3.33 | 6.25 |

The SNR loss due to puncturing, with Option #2, is as follows:

| Interference | |
|---|---|
| power vs. | |
| PBCH power | SNR loss (dB) due to puncturing |

| (dB) | 2 PRBs | 4 PRBs | 6 PRBs | 8 PRBs |
|---|---|---|---|---|
| −100 | 1.11 | 2.5 | 4.61 | 7.53 |
| 0 | 1.35 | 4.25 | 14.84 | 38.09 |

### Observations:

Option #1 is preferred: Puncturing of at least 6 PRBs can be supported with reasonable (<3.5 dB performance degradation). A part of that can be compensated by power boost where the unused power of punctured PRBs is allocated to the transmitted PRBs.
It may be beneficial for the UE to know the puncturing pattern (and basically whether puncturing is applied or not).

Accordingly, it may be beneficial for the UE to determine whether or not to assume puncturing applied for the synchronization and physical broadcast channel block (SSB), and in particular, also to determine which PRBs are punctured. SSB detection, i.e. PSS/SSS and PBCH demodulation and decoding, is the first operation UE does in order to access the cell.

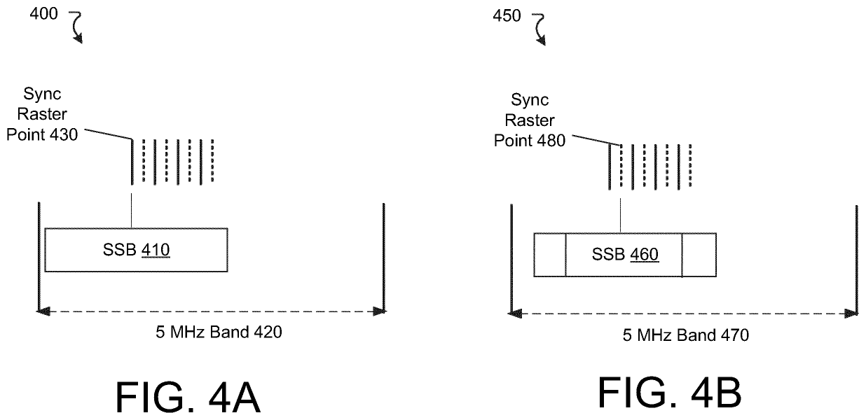

The UE may need prior knowledge or assumption for the used puncturing pattern in PBCH demodulation and decoding. The UE may determine a puncturing pattern from a detected synchronization signal raster point. In other words, the sync raster points may be classified as (i) ones that indicate puncturing or (ii) others that do not indicate puncturing (i.e., existing sync raster points). This is illustrated in FIGS. 4A and 4B.

FIG. 4A is a diagram illustrating puncturing 400 based on a sync raster point 430 on a frequency band 420 from which a SSB 410 is detected. In FIG. 4A, solid lines represent no puncturing; dashed lines represent puncturing. Accordingly, the sync raster point 430 is classified as indicating no puncturing.

FIG. 4B is a diagram illustrating puncturing 450 based on a sync raster point 480 on a frequency band 470 from which a SSB 460 is detected. In FIG. 4B, solid lines represent no puncturing; broken lines represent puncturing. Accordingly, the sync raster point 480 is classified as indicating puncturing.

A specific problem is that sync raster point cannot unambiguously provide a puncturing pattern. That is, the problem is that there may be need for multiple different puncturing patterns like 1+4 (1 PRB from low edge of SSB and 4 PRBs from high end of SSB), 2+3, 3+2 and 4+1. It may be impractical to assign different synch raster points to different puncturing patterns explicitly.

In contrast to the known conventional approaches to determining punctured PRBs for an SSB, improved techniques include determining a puncturing to be applied to an incoming SSB if the SSB falls out of band or upon a minimum guard band of the band. In some implementations, when there is a specified total puncturing, the UE performs puncturing on resources at the opposite end of the SSB if needed to reach the specified total puncturing. When there a total puncturing is not specified, the UE performs the same amount of puncturing on resources at the opposite end of the SSB.

The above-described improved technique for determining punctured PRBs has advantages over the conventional approaches, including the following.
The UE can unambiguously determine the puncturing pattern used for the PBCH and can then perform optimal PBCH demodulation and decoding.
   PBCH DMRS may be detected optimally as well.
Enables unambiguous indication of multiple different puncturing patterns without additional signalling—PSS/SSS and PBCH design is not changed.
There is no need to add new sync raster points to indicate puncturing but can utilize the existing raster but that are not valid for the band in the current NR operation.
No hardware changes needed at the UE.

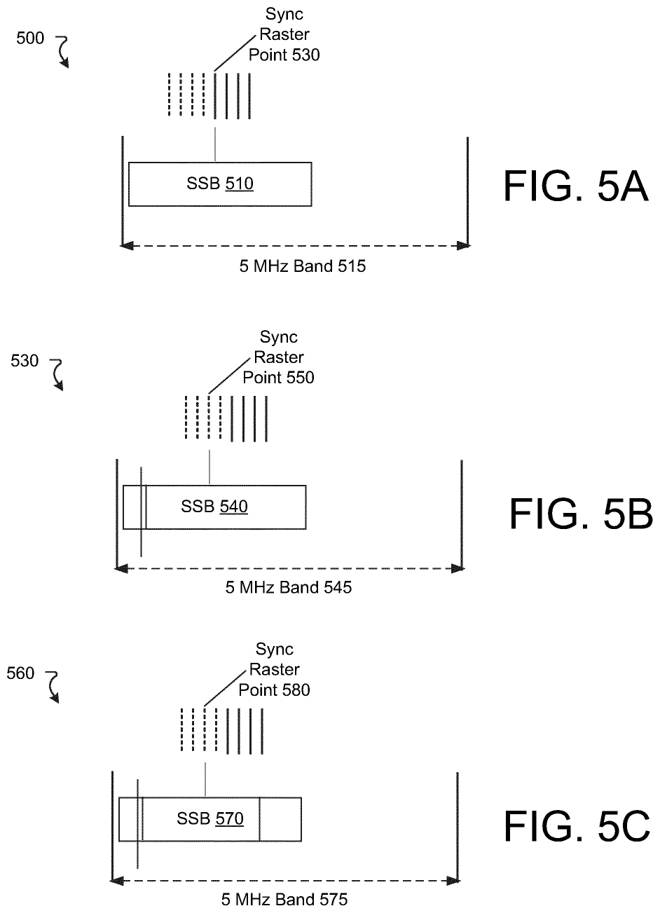

FIGS. 5A-5C is a diagram illustrating an improved puncturing procedure 500, 530, 560 by which a puncturing pattern may be determined. In FIG. 5A, the puncturing is based on a sync raster point 520 on a frequency band 515 from which a SSB 510 is detected. In FIG. 5A, solid lines represent no puncturing; dashed lines represent puncturing. Accordingly, the sync raster point 520 is classified as indicating no puncturing.

FIG. 5B is a diagram illustrating a portion of an improved puncturing procedure 530 by which a puncturing pattern may be determined. The puncturing is based on a sync raster point 550 on a frequency band 545 from which a SSB 540 is detected. In FIG. 5B, solid lines represent no puncturing; dashed lines represent puncturing. Accordingly, the sync raster point 550 is classified as indicating puncturing. It is also noted that the SSB has a guard band at one end.

At 530, the UE determines the puncturing that is applied if the SSB would go out of given band or would fall upon the minimum guard band of the band.
I. The UE uses for the determination the sync raster point on which the UE detected SSB (PSS/SSS), the edge of the frequency band and the required minimum guard band in the band.
   In this context the minimum guard band is likely based on 5 MHz and/or 3 MHz channel bandwidth assumption and 15 kHz SCS.
      i. In some implementations, only 3 MHz channel bandwidth (CBW) is relevant; accordingly in such implementations a 3 MHz CBW followed.
      ii. In some implementations, only 5 MHz channel bandwidth (CBW) is relevant; accordingly in such implementations a 5 MHz CBW followed.
      iii. In some implementations, in some frequency bands, both 3 MHz CBW and 5 MHz CBW are relevant. In such implementations, the UE may determine the guard band according to 3 MHz CBW or according to 5 MHz CBW. This determination may be performed according to predefined rules, e.g. CBW according to maximum guard band, or according to minimum guard band.
II. The UE determines the punctured resources on one side of SSB by taking into account the defined minimum guard band in the band, i.e. resources in the guard band and outside of the band are assumed to be punctured
   Furthermore, there may be additionally/alternatively a predefined number of frequency domain resources/frequency domain distance to edge of the minimum guard band and/or band edge that is used to determine whether or not puncturing is applied. In other words, puncturing is assumed if the SSB would fall upon the resources defined by a predefined number of frequency domain resources/frequency domain distance to edge of the minimum guard band and/or band edge.
III. The UE may determine puncturing based on full RB assumption for the puncturing granularity of SSB, i.e. PBCH is transmitted only on full PRBs within the band and not upon minimum guard band. If a PRB is partially punctured, the whole PRB will be punctured.
IV. As a result of above the UE determines the number of PRBs punctured on one side of SSB and denote it as Y.

FIG. 5C is a diagram illustrating a portion of an improved puncturing procedure 560 by which a puncturing pattern may be determined. The puncturing is based on a sync raster point 580 on a frequency band 575 from which a SSB 570 is detected. In FIG. 5C, solid lines represent no puncturing; dashed lines represent puncturing. Accordingly, the sync raster point 580 is classified as indicating puncturing. It is also noted that the SSB is punctured at both ends.

At 560, the UE assumes puncturing in other end to end up with X in total PRBs.
I. The UE may assume the puncturing in the other end of SSB to be the same as Y (or Y−1 or Y+1) above or the puncturing in the other end of SSB to be such that the total number of non-punctured PRBs is X where X is predefined/standardized (e.g. 15), and X is always >=12. For example, when X=15, then there are 5 PRBs to be punctured. When Y=1, then there are to be four punctured PRBs on the other end of the SSB. Accordingly, the puncturing pattern is 1+4.

In the improved techniques, the sync raster points that wouldn't be valid synch raster points in the current NR system are utilized (because SSB cannot fit into the band of interests). By this, it is not necessary to add new sync raster points to indicate puncturing but can utilize the existing raster points that are in the band but not usable in the current NR operation.

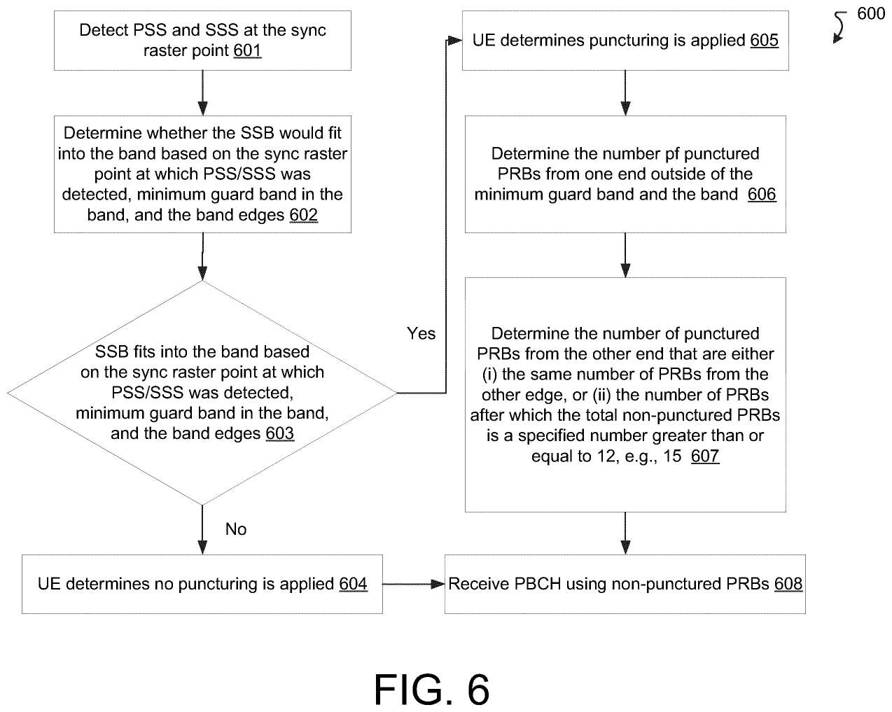

FIG. 6 is a flow chart illustrating a process 600 to determine a SSB puncturing pattern from a UE perspective.

At 601, the UE detects PSS/SSS on a sync raster point on the band of interest.

At 602, the UE calculates whether SSB would fit into the band based on the sync raster point PSS/SSS was detected, minimum guard band in the band and the band edges. In some implementations, the UE may use a predefined frequency domain distance to guard band or band edge.

At 603, if the UE determines based on the calculation that the SSB would not fit into the band (or predefined portion of band) the UE determines at 605 that puncturing is applied; otherwise, the UE determines at 604 that no puncturing is applied.

If puncturing is applied at 605:

At 606, the UE determines the number of punctured PRBs from one end of SSB being the ones that fall upon the minimum guard band and/or outside the band.

At 607, the UE determines the number of punctured PRBs from the other end of SSB being the one that is either
the same number of PRBs as punctured from the other edge, or
the number of PRBs after which the total non-punctured PRBs of SSB is certain number, like 15 (but always >=12).

At 608, the UE receives PBCH using non-punctured PRBs.

If no puncturing is applied at 604:

At 608, the UE receives PBCH using non-punctured PRBs.

In some implementations, the UE performs PBCH demodulation and decoding based on the non-punctured PRBs determined above. In some implementations, the UE may also assume the same non-punctured PRBs valid for the subsequent steps like determining valid resources for the CORESET #0 on which the UE monitors, e.g., Type0-PDCCH. In some implementations, the UE uses determined non-punctured PRBs information for further downlink subframes in a given carrier until the UE is indicated to change configuration by the network. In some implementations, the puncturing pattern for PDCCH is not exactly the same as that for PBCH; for example, the CCE granularity may be used for PDCCH. In some implementations, the puncturing pattern for CORESET #0 is determined based on the non-punctured PRBs.

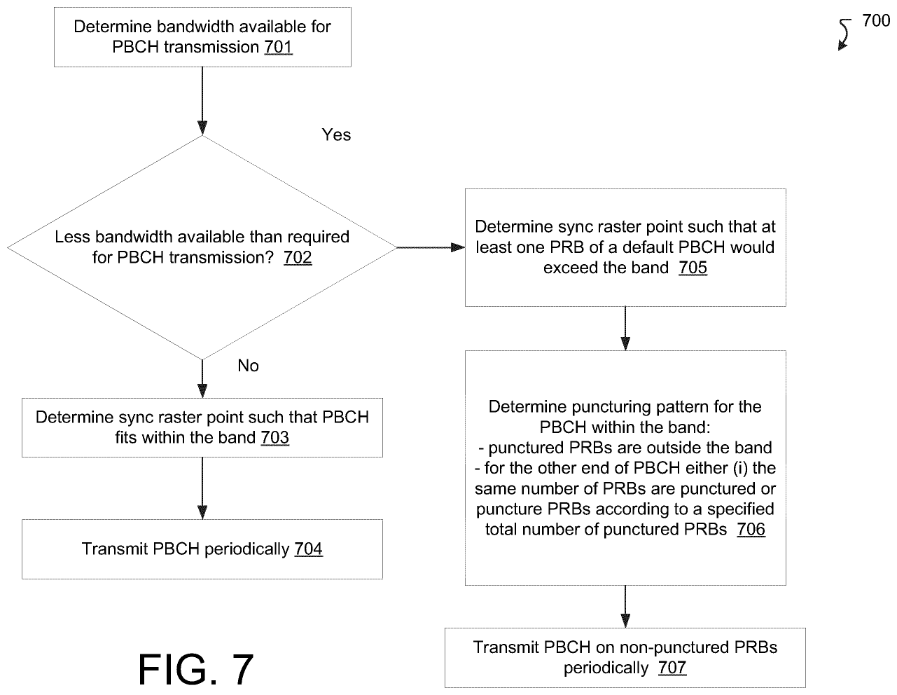

FIG. 7 is a flow chart illustrating a process 700 to determine a SSB puncturing pattern from a gNB perspective.

At 701, the gNB determines bandwidth available for PBCH transmission. In some implementations, the bandwidth is provided to the gNB by another network element.

At 702, it is determined whether the bandwidth available is less than required for PBCH transmission.

If there is not less bandwidth available than that required for PBCH transmission:

At 703, the gNB determines a sync raster point such that the PBCH is located within the frequency band.

At 704, the gNB transmits the PBCH periodically.

If there is less bandwidth available than that required for PBCH transmission:

At 705, the gNB determines a sync raster point such that at least one PRB of a default PBCH would exceed the band. This indicates that puncturing occurs to UE. When the same number of PRBs is punctured from both ends of PBCH, this also determines the punctured PBCH bandwidth.

At 706, the gNB determines a puncturing pattern for the PBCH within the band:
punctured PRBs are outside the band,
for the other end of the PBCH, either (i) the same number of PRBs are punctured, or (ii) PRBs are punctured according to a specified number of punctured PRBs.

At 707, the gNb transmits the PBCH on non-punctured PRBs periodically.

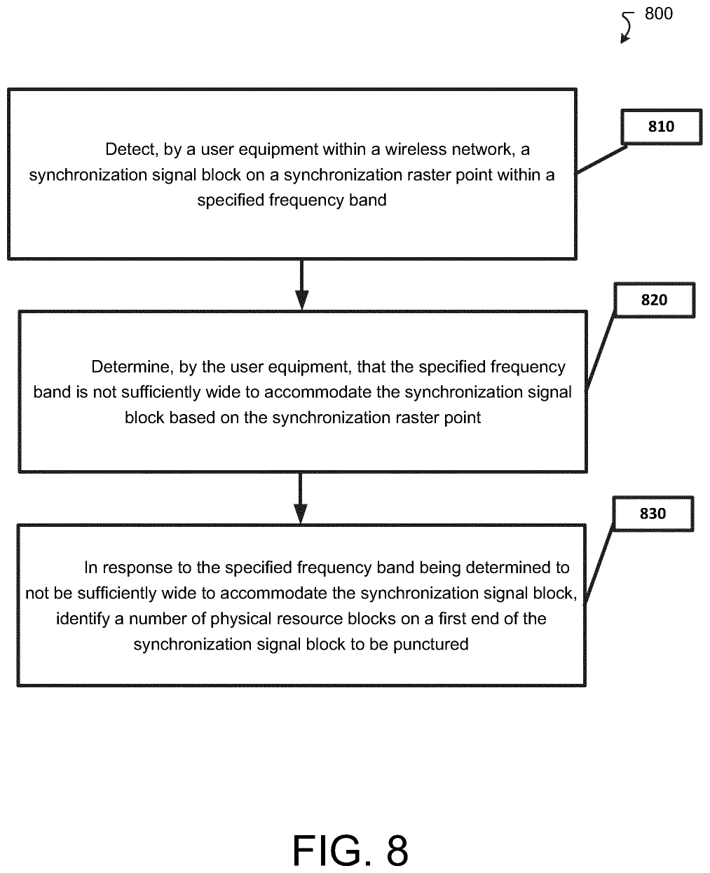

Example 1-1: FIG. 8 is a flow chart illustrating a process 800 of determining puncturing of PRBs for a SSB. Operation 810 includes detecting, by a user equipment within a wireless network, a synchronization signal block on a synchronization raster point within a specified frequency band. Operation 820 includes determining, by the user equipment, that the specified frequency band is not sufficiently wide to accommodate the synchronization signal block based on the synchronization raster point. Operation 830 includes, in response to the specified frequency band being determined to not be sufficiently wide to accommodate the synchronization signal block, identifying a number of physical resource blocks on a first end of the synchronization signal block to be punctured.

Example 1-2: According to an example implementation of example 1-1, wherein the identified number of physical resource blocks on the first end of the synchronization signal block to be punctured is based on a size of a guard band on an end of the band closest to the first end of the synchronization signal block, the first end of the synchronization signal block being closer to the end of the band closest to the first end of the synchronization signal block than a second end of the synchronization signal block is to a second end of the synchronization signal block.

Example 1-3: According to an example implementation of example 1-2, wherein determining that the specified frequency band is not sufficiently wide to accommodate the synchronization signal block based on the synchronization raster point includes determining based on transmitting a physical broadcast channel only on full physical resource blocks within the band and not upon the guard band.

Example 1-4: According to an example implementation of examples 1-1 to 1-3, wherein determining that the specified frequency band is not sufficiently wide to accommodate the synchronization signal block based on the synchronization raster point includes determining whether there are a specified minimum number of frequency resources adjacent to an end of the band closest to the first end of the synchronization signal block.

Example 1-5: According to an example implementation of examples 1-1 to 1-4, wherein determining that the specified frequency band is not sufficiently wide to accommodate the synchronization signal block based on the synchronization raster point includes determining whether there is a specified minimum frequency domain distance from an end of the band closest to the first end of the synchronization signal block.

Example 1-6: According to an example implementation of examples 1-1 to 1-5, further comprising identifying physical resource blocks on a second end of the synchronization signal block, opposite the first end of the synchronization signal block, to be punctured according to a specified rule.

Example 1-7: According to an example implementation of example 1-6, wherein a number of non-punctured physical resource blocks of the synchronization signal block are specified, and wherein the specified rule by which the physical resource blocks on the second end of the synchronization signal block are identified includes a rule to identify the physical resource blocks on the second end of the synchronization signal block based on the specified number of non-punctured physical resource blocks of the synchronization signal block and the number of physical resource blocks on the first end of the synchronization signal block to be punctured.

Example 1-8: According to an example implementation of example 1-6, wherein the specified rule by which the physical resource blocks on the second end of the synchronization signal block are identified includes a rule to identify the physical resource blocks on the second end of the synchronization signal block to be punctured is the same as the number of physical resource blocks on a first end of the synchronization signal block to be punctured.

Example 1-9: According to an example implementation of example 1-6, wherein the specified rule by which the physical resource blocks on the second end of the synchronization signal block are identified includes a rule to identify the physical resource blocks on the second end of the synchronization signal block to be punctured is one more than the number of physical resource blocks on a first end of the synchronization signal block to be punctured.

Example 1-10: to an example implementation of example 1-6, wherein the specified rule by which the physical resource blocks on the second end of the synchronization signal block are identified includes a rule to identify the physical resource blocks on the second end of the synchronization signal block to be punctured is one less than the number of physical resource blocks on a first end of the synchronization signal block to be punctured.

Example 1-11: An apparatus comprising means for performing a method of any of examples 1-1 to 1-10.

Example 1-12: A computer program product including a non-transitory computer-readable storage medium and storing executable code that, when executed by at least one data processing apparatus, is configured to cause the at least one data processing apparatus to perform a method of any of examples 1-1 to 1-10.

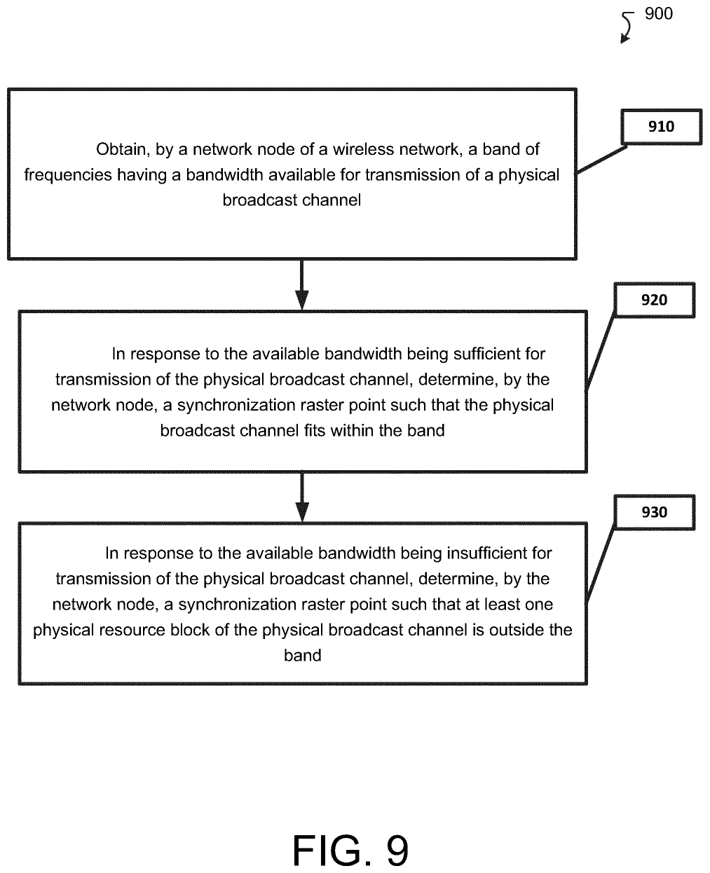

Example 2-1: FIG. 9 is a flow chart illustrating a process 900 of determining puncturing of PRBs for a SSB. Operation 910 includes obtaining, by a network node of a wireless network, a band of frequencies having a bandwidth available for transmission of a physical broadcast channel. Operation 920 includes, in response to the available bandwidth being sufficient for transmission of the physical broadcast channel, determining, by the network node, a synchronization raster point such that the physical broadcast channel fits within the band. Operation 930 includes, in response to the available bandwidth being insufficient for transmission of the physical broadcast channel, determining, by the network node, a synchronization raster point such that at least one physical resource block of the physical broadcast channel is outside the band.

Example 2-2: According to an example implementation of example 2-1, wherein the band includes a guard band, and the available bandwidth corresponds to portions of the band outside of the guard band.

Example 2-3: According to an example implementation of examples 2-1 to 2-2, wherein, in response to the available bandwidth being sufficient for transmission of the physical broadcast channel, the method further comprises transmitting the physical broadcast channel periodically.

Example 2-4: According to an example implementation of examples 2-1 to 2-3, wherein, in response to the available bandwidth being insufficient for transmission of the physical broadcast channel, the method further comprises obtaining a pattern identifying physical resource blocks that are punctured according to their being outside the band; and transmitting the physical broadcast channel on the physical resource blocks that are not punctured.

Example 2-5: According to an example implementation of example 2-4, wherein transmitting the physical broadcast channel on the physical resource blocks that are not punctured further includes transmitting the physical broadcast channel periodically.

Example 2-6: An apparatus comprising means for performing a method of any of examples 2-1 to 2-5.

Example 2-7: A computer program product including a non-transitory computer-readable storage medium and storing executable code that, when executed by at least one data processing apparatus, is configured to cause the at least one data processing apparatus to perform a method of any of examples 2-1 to 2-5.

### LIST OF EXAMPLE ABBREVIATIONS

CBW Channel Bandwidth
DMRS Demodulation Reference Signal
gNB 5G Node B
MIB Master Information Block
OFDM Orthogonal Frequency Domain Multiplexing
PBCH Physical Broadcast Channel
PRB Physical Resource Block
PSS Primary Synchronization Signal
RE Resource Element
RB Resource Block
RRC Radio Resource Control
SCS Subcarrier Spacing
SIB System Information Block
SSB Synchronization Signal Block
SSS Secondary Synchronization Signal
UE User Equipment

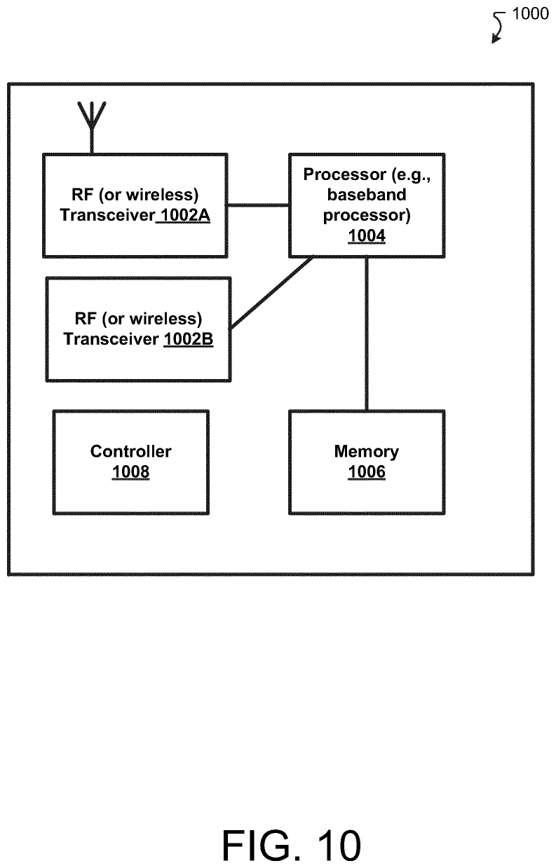

FIG. 10 is a block diagram of a wireless station (e.g., AP, BS, e/gNB, NB-IoT UE, UE or user device) 1000 according to an example implementation. The wireless station 1000 may include, for example, one or multiple RF (radio frequency) or wireless transceivers 1002A, 1002B, where each wireless transceiver includes a transmitter to transmit signals (or data) and a receiver to receive signals (or data). The wireless station also includes a processor or control unit/entity (controller) 1004 to execute instructions or software and control transmission and receptions of signals, and a memory 1006 to store data and/or instructions.

Processor 1004 may also make decisions or determinations, generate slots, subframes, packets or messages for transmission, decode received slots, subframes, packets or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 10, a controller (or processor) 1008 may execute software and instructions, and may provide overall control for the station 1000, and may provide control for other systems not shown in FIG. 10 such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example implementation, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1. An apparatus, comprising:
at least one processor; and
at least one memory including computer program code;
the at least one memory and the computer program code configured to cause the apparatus at least to:
detect, by a user equipment within a wireless network, a synchronization signal block on a synchronization raster point within a specified frequency band;
determine, by the user equipment, that the specified frequency band is not sufficiently wide to accommodate the synchronization signal block based on the synchronization raster point;
in response to the specified frequency band being determined to not be sufficiently wide to accommodate the synchronization signal block, identify a number of physical resource blocks on a first end of the synchronization signal block to be punctured.

2. The apparatus as in claim 1, wherein the identified number of physical resource blocks on the first end of the synchronization signal block to be punctured is based on a size of a guard band on an end of the band closest to the first end of the synchronization signal block, the first end of the synchronization signal block being closer to the end of the band closest to the first end of the synchronization signal block than a second end of the synchronization signal block is to a second end of the synchronization signal block.

3. The apparatus as in claim 2, wherein the at least one memory and the computer program code configured to determine that the specified frequency band is not sufficiently wide to accommodate the synchronization signal block based on the synchronization raster point is further configured to cause the apparatus at least to:
determine based on transmitting a physical broadcast channel only on full physical resource blocks within the band and not upon the guard band.

4. The apparatus as in claim 1, wherein the at least one memory and the computer program code configured to determine that the specified frequency band is not sufficiently wide to accommodate the synchronization signal block based on the synchronization raster point is further configured to cause the apparatus at least to:
determine whether there are a specified minimum number of frequency resources adjacent to an end of the band closest to the first end of the synchronization signal block.

5. The apparatus as in claim 1, wherein the at least one memory and the computer program code configured to determine that the specified frequency band is not sufficiently wide to accommodate the synchronization signal block based on the synchronization raster point is further configured to cause the apparatus at least to:
determine whether there is a specified minimum frequency domain distance from an end of the band closest to the first end of the synchronization signal block.

6. The apparatus as in claim 1, wherein the at least one memory and the computer program code are further configured to cause the apparatus at least to:
identify physical resource blocks on a second end of the synchronization signal block, opposite the first end of the synchronization signal block, to be punctured according to a specified rule.

7. The apparatus as in claim 6, wherein a number of non-punctured physical resource blocks of the synchronization signal block are specified, and
wherein the specified rule by which the physical resource blocks on the second end of the synchronization signal block are identified includes a rule to identify the physical resource blocks on the second end of the synchronization signal blockbased on the specified number of non-punctured physical resource blocks of the synchronization signal block and the number of physical resource blocks on the first end of the synchronization signal block to be punctured.

8. The apparatus as in claim 6, wherein the specified rule by which the physical resource blocks on the second end of the synchronization signal block are identified includes a rule to identify the physical resource blocks on the second end of the synchronization signal block
to be punctured is the same as the number of physical resource blocks on a first end of the synchronization signal block to be punctured.

9. The apparatus as in claim 6, wherein the specified rule by which the physical resource blocks on the second end of the synchronization signal block are identified includes a rule to identify the physical resource blocks on the second end of the synchronization signal block to be punctured is one more than the number of physical resource blocks on a first end of the synchronization signal block to be punctured.

10. The apparatus as in claim 6, wherein the specified rule by which the physical resource blocks on the second end of the synchronization signal block are identified includes a rule to identify the physical resource blocks on the second end of the synchronization signal block to be punctured is one less than the number of physical resource blocks on a first end of the synchronization signal block to be punctured.

11. A method, comprising:
detecting, by a user equipment within a wireless network, a synchronization signal block on a synchronization raster point within a specified frequency band;
determining, by the user equipment, that the specified frequency band is not sufficiently wide to accommodate the synchronization signal block based on the synchronization raster point;
in response to the specified frequency band being determined to not be sufficiently wide to accommodate the synchronization signal block, identifying a number of physical resource blocks on a first end of the synchronization signal block to be punctured.

12. The method as in claim 11, wherein the identified number of physical resource blocks on the first end of the synchronization signal block to be punctured is based on a size of a guard band on an end of the band closest to the first end of the synchronization signal block, the first end of the synchronization signal block being closer to the end of the band closest to the first end of the synchronization signal block than a second end of the synchronization signal block is to a second end of the synchronization signal block.

13. The method as in claim 12, wherein determining that the specified frequency band is not sufficiently wide to accommodate the synchronization signal block based on the synchronization raster point includes:
determining based on transmitting a physical broadcast channel only on full physical resource blocks within the band and not upon the guard band.

14. The method as in claim 11, wherein determining that the specified frequency band is not sufficiently wide to accommodate the synchronization signal block based on the synchronization raster point includes:
determining whether there are a specified minimum number of frequency resources adjacent to an end of the band closest to the first end of the synchronization signal block.

15. The method as in claim 11, wherein determining that the specified frequency band is not sufficiently wide to accommodate the synchronization signal block based on the synchronization raster point includes:
determining whether there is a specified minimum frequency domain distance from an end of the band closest to the first end of the synchronization signal block.

16. The method as in claim 11, further comprising:
identifying physical resource blocks on a second end of the synchronization signal block, opposite the first end of the synchronization signal block, to be punctured according to a specified rule.

17. The method as in claim 16, wherein a number of non-punctured physical resource blocks of the synchronization signal block are specified, and
wherein the specified rule by which the physical resource blocks on the second end of the synchronization signal block are identified includes a rule to identify the physical resource blocks on the second end of the synchronization signal blockbased on the specified number of non-punctured physical resource blocks of the synchronization signal block and the number of physical resource blocks on the first end of the synchronization signal block to be punctured.

18. The method as in claim 16, specified rule by which the physical resource blocks on the second end of the synchronization signal block are identified includes a rule to identify the physical resource blocks on the second end of the synchronization signal block to be punctured is the same as the number of physical resource blocks on a first end of the synchronization signal block to be punctured.

19. The method as in claim 16, wherein the specified rule by which the physical resource blocks on the second end of the synchronization signal block are identified includes a rule to identify the physical resource blocks on the second end of the synchronization signal block to be punctured is one more than the number of physical resource blocks on a first end of the synchronization signal block to be punctured.

20. The method as in claim 16, wherein the specified rule by which the physical resource blocks on the second end of the synchronization signal block are identified includes a rule to identify the physical resource blocks on the second end of the synchronization signal block to be punctured is one less than the number of physical resource blocks on a first end of the synchronization signal block to be punctured.

21-32. (canceled)
